(19) United States
(12) Patent Application Publication
(10) Pub. No.: US 2010/0196150 A1
(43) Pub. Date: Aug. 5, 2010

(54) BOUNDARY LAYER WIND TURBINE WITH TANGENTIAL ROTOR BLADES

(76) Inventor: Horia Nica, Laval (CA)

Correspondence Address: GOUDREAU GAGE DUBUC, 2000 MCGILL COLLEGE, SUITE 2200, MONTREAL, QC, H3A 3H3, CA

(21) Appl. No.: 12/668,309

(22) PCT Filed: Jul. 9, 2007
(86) PCT No.: PCT/CA2007/001200

§ 371 Date: Jan. 8, 2010

(51) Int. Cl. F03D 3/04; F03D 9/00; F03D 3/06; F03D 11/00; F03D 1/06

(52) U.S. Cl. 415/191; 290/55; 416/223 R; 416/90 R

(57) ABSTRACT

A wind turbine having rotor assembly with a plurality of stacked disks (1) for rotation about an axis. At least one set of the stacked disks has disks being closely spaced from each other for creating a boundary layer effect on surfaces of the disks that contributes in rotating the disks. Each disk has a plurality of rotor blades (2) disposed on an outer circumference thereof. Each rotor blade (2) has at least one surface extending tangentially from the outer circumference of each disk (1) for redirecting the airflow tangentially to a peripheral surface of each disk (1). Each disk (1) defines at least one opening (4) thereon for redirecting the wind axially through each of the disks (1).

### FIELD OF THE INVENTION

The present invention relates to wind turbines used to convert wind energy into mechanical energy, more specifically to wind turbines that uses the phenomenon of boundary layer on a surface to extract the wind energy.

### BACKGROUND OF THE INVENTION

Wind as a source of energy is a concept that has been promoted from ancient time. According to historical sources, there is evidence which shows that windmills were in use in Babylon and in China as early as 2000 B.C.

Wind is used as a source of energy for driving horizontal axis and vertical axis windmills. Horizontal axis windmills have been used extensively to drive electrical generators, however they suffer from several disadvantages, including the need for an even horizontal air inflow, danger to birds and air traffic, obscuring the landscape with banks of rotating windmills, and in the case of large diameter horizontal axis propellers, supersonic speeds at the tips of the rotors.

Vertical axis wind turbines (VAWT) have been provided in the prior art with a central rotor surrounded by stationary devices that serve to redirect and compress air flow toward the rotor blades.

Compared to VAWT where its exposure remains constant regardless of the wind direction, the horizontal axis windmill must turn to face the wind direction, which is considered a disadvantage as there are additional moving parts involved in the construction.

An example of vertical axis wind turbine is shown in U.S. Pat. No. 5,391,926 to Staley et al. that uses double curved stator blades to direct wind current to the rotor assembly and to increase structure stability of the thin stator blades.

U.S. Pat. No. 6,015,258 to Taylor discloses another wind turbine that includes a ring of stator blades of an airfoil shape to reduce impedance of air directed towards the central rotor assembly.

Further, U.S. Patent Application Publication No. 2002/0047276 A1 (ELDER) discloses an outer ring of planar stator blades to direct flow of wind into a central rotor assembly.

Canadian Patent No. 1,126,656 (SHARAK) discloses a vertical axis turbine with stator blades that redirect the air to the rotor blades by straight extending vertical air guide panels that intermittently surround the rotor unit and direct air currents to the rotor unit for rotation by the wind. The air guide panels are closed at the top and bottom by horizontally extending guide panels that are canted in complementary directions. The upper panel is tilted downwardly as it progresses inwardly and the lower panel is tilted upwardly on its inward extent to thereby increase the velocity and pressure of the wind as it is directed to the rotor unit.

Another Canadian Patent Application No. 2,349,443 (TETRAULT) discloses a new concept of vertical axis wind turbine comprising an air intake module, which redirects the airflow vertically to a series of rings with parabolic evacuations. One of the major drawbacks of that design is the fact that the air intake module needs to face the wind, so it requires a yaw mechanism to orient it into the wind. Moreover, the whole design forces the airflow to change its direction from horizontal to vertical into a sort of internal enclosure from where the air is evacuated by changing again its direction from vertical to horizontal. The numerous and drastic changes in airflow directions entail a power loss in the airflow and a reduction of the turbine efficiency, as the energy of the wind is transformed into rotation of the turbine only at the last airflow direction change.

A disadvantage of all the horizontal and vertical axis windmills of the prior art relates to their inability to use remaining energy left in the airflow after hitting the windmill blades. Ideally, the airflow exiting a blade will be reused again and again to a certain extent. Unfortunately, in most cases the prior art enables the capture of only a fraction, the first impulse, of the wind power.

A prior art that uses the fluids' properties to transform efficiently a linear fluid movement into a rotational mechanical movement is the turbine described in U.S. Pat. No. 1,061,142 accorded to Nikola Tesla in 1913. The Tesla turbine used a plurality of rotating disks enclosed inside a volute casing and the rotation of the turbine was due to a viscous high-pressured fluid, oil in Tesla experiments, directed tangentially to the disks. Unfortunately this previous art is not suited to capture wind energy for several reasons such as the air viscosity is too low, the normal wind speed is too low and the whole design with a casing enclosure and only one access opening is impractical for wind turbines.

The International Patent Application No. PCT/CA2006/000278, attributed to the applicant, and published under No. WO2006089425A1 discloses a wind turbine including a stator assembly having a plurality of stator blades for tangentially redirecting wind into a rotor assembly having a plurality of vertical rotor blades disposed circumferentially on a plurality of disks stacked one on top of each other. The extraction of the wind energy using the boundary layer effect, via stacked disks, proves to be very efficient over the portion of the air flow that enters between the rotor's disks. However, one of the drawbacks of that design is the fact that the stator assembly, as designed with the stator blades redirecting the wind tangentially into the rotor, creates around the rotor a natural enclosure that prevents the air flow to enter or exit easily, hence creating a region of high pressure in front of the turbine forcing the majority of the air flow to diverge from its path onto the turbine, which ultimately reduces the wind turbine's total efficiency.

There is therefore a need for a boundary layer stacked disk design that does not need any stator assembly, allowing the airflow to enter and exit freely into and from the rotor assembly.

### OBJECTS OF THE INVENTION

It is a preferred object of the present invention to provide a vertical axis wind turbine boundary layer stacked disk design where the air flow is imparted tangentially to the disks without any need for stator assembly.

It is a further preferred object of the invention to provide a turbine assembly that is structurally reinforced.

It is a further preferred object of the invention to provide a turbine assembly that is simply constructed of inexpensive light material.

It is a further preferred object of the present invention to provide a vertical axis wind turbine based on the Coanda effect in fluids which translates into an efficient wind turbine.

### SUMMARY OF THE INVENTION

According to the present invention, there is provided a wind turbine comprising a rotor assembly having a plurality of stacked disks for rotation about an axis, at least one set of the stacked disks having disks being closely spaced from each other for creating a boundary layer effect on surfaces of the disks that contributes in rotating the disks, each disk having a plurality of rotor blades disposed on an outer circumference thereof, each rotor having at least one surface extending tangentially from the outer circumference of each disk so as to redirect the airflow tangentially to a peripheral surface of each disk, each disk defining at least one opening thereon for redirecting the wind axially through each of the disks.

Preferably, a wind turbine according to the present invention is able to operate in very broad wind conditions, such as velocities up to 130 mph (200 Km/h), and frequently changing wind directions. The device provides a reliable and effective means for directing air currents into the rotor assembly, which is attached directly to a vertical shaft.

In general terms, the invention involves various embodiments of a vertical-axis wind turbine. Preferably, the rotor blades are designed with an airfoil profile and disposed tangentially to the disks. The rotor blades are disposed around the circumference of the disks as such that, regardless of the wind direction, the air inflow will be redirected tangentially to the disks' surfaces to impart a higher rotational velocity and greater torque upon the turbine shaft. In a preferred embodiment, the rotor blades are angled from the vertical direction and form a helical shape to allow smooth transitions of the blades over the incoming airflow.

The turbine may be equipped with any number of disks; however a preferred embodiment has at least 50 disks.

In a preferred embodiment, the turbine is designed with an airflow augmenter stator assembly where the stator blades impart the airflow directly into the rotor assembly. The significant size difference between the inflow and the outflow openings of the air channels created by the stator blades create a natural compression and a substantial air speed increase that achieve higher efficiency even in low wind. The disposition of the stator blades also prevents the disruption of rotation by shielding the rotors from winds counter-directional to their rotation which may occur as the wind shifts. The stator assembly may be equipped with any number of stator blades; however a preferred embodiment has between six and twelve stator blades.

Preferably, the wind turbine acts to convert wind currents into mechanical energy used to directly act upon a water pump, or to drive an electrical generator for use as an alternate power source.

The invention as well as its numerous advantages will be better understood by reading of the following non-restrictive description of preferred embodiments made in reference to the appending drawings.

### BRIEF DESCRIPTION OF THE DRAWINGS

FIG. 1 is a perspective view of a vertical axis wind turbine as seen from the exterior, where the airfoil shape and the tangent disposition of the rotor blades are visible, according to a preferred embodiment of the present invention.

FIG. 2 is a top view of a disk presenting the tangent airfoil blades continued with the ribs as in FIG. 1.

FIG. 3 is a perspective view of an assembly of ten (10) disks as in FIG. 1 providing more details thereof.

FIG. 4 is a perspective view of the turbine with an airflow augmenter stator assembly, according to a preferred embodiment of the present invention.

### DETAILED DESCRIPTION OF THE INVENTION

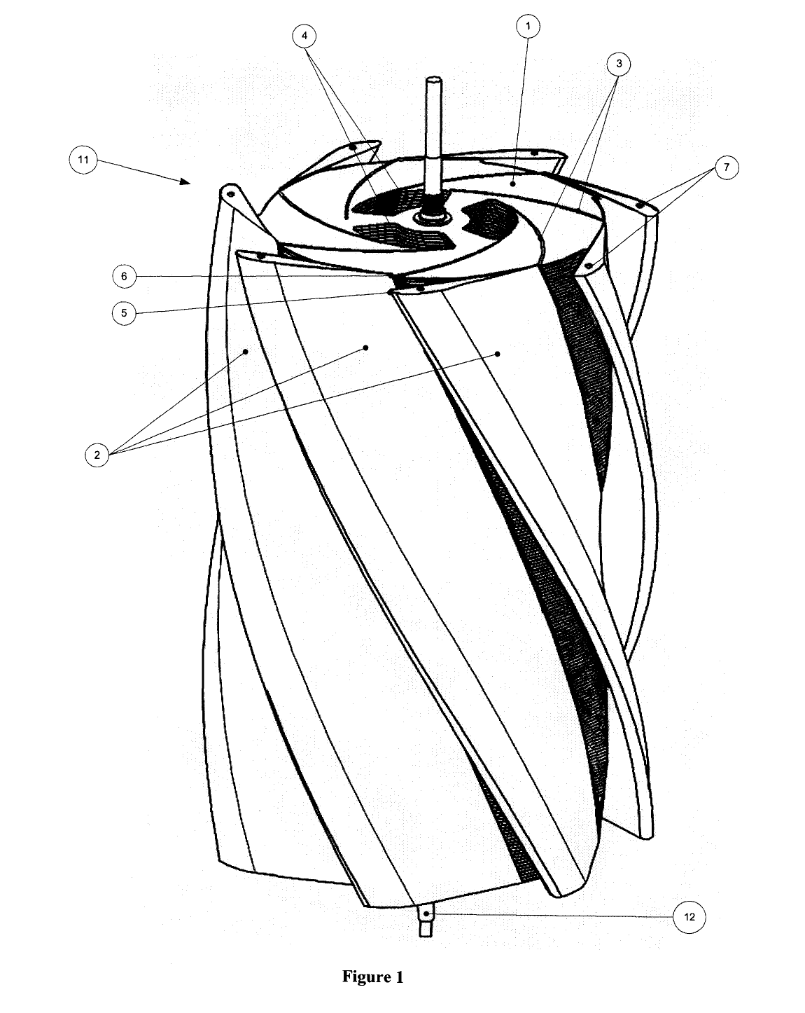

FIG. 1 shows a vertical axis wind turbine as seen from the exterior, where the airfoil shape and the tangent disposition of the rotor blades 2 are visible, according to a preferred embodiment of the present invention. The rotor blades 2 redirect the airflow tangentially to the disk surface 1. The rotor assembly 11 is mountably connected to the shaft 12.

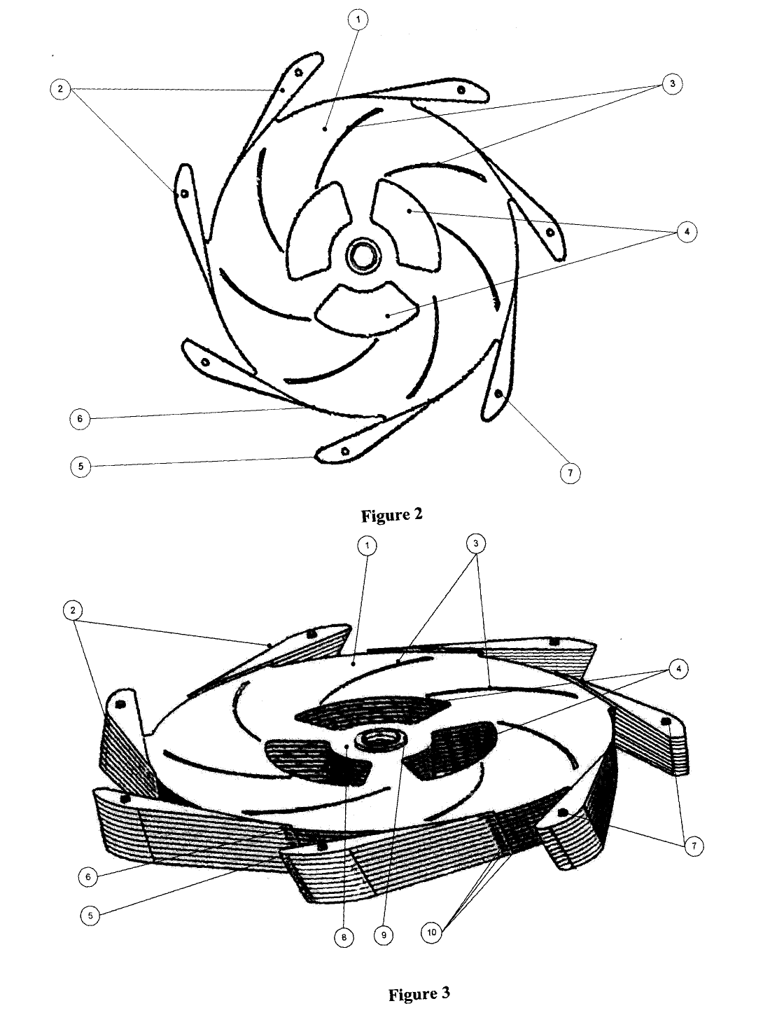

FIG. 2 is a top view of a single internal disk presenting the airfoil blades 2 uniformly distributed on the circumference of the disk. The upper and lower surface of the disk 1 may be equipped with a certain number of ribs 3. In a preferred embodiment, each blade 2 has a corresponding rib on the upper surface and between two blades 2 there is a corresponding rib on the lower surface. The disk 1 may be equipped with any number of blades 2. However, in a preferred embodiment the number of blades 2 is between six (6) and twelve (12). Similar to Tesla disks, each disk may have three arc-sector openings 4 to let the air circulate between the disks. The ribs 3 are disposed in a spiral arrangement and project from one corresponding rotor blade 2 on the circumference of the disk 1 to the outer circumference of the openings 4.

The airfoil shape of the rotor blades 2 and their tangential disposition to the disk circumference redirect the airflow tangentially to the surface of disk. The length of the blade 2 and the number of the blades on the circumference of the disk are in a close relationship, as such that the gap between the tip of a blade 5 and the tail 6 of the next blade prevents any airflow to travel in a counter-rotating direction between the disks 1.

FIG. 3 shows an assembly of ten (10) disks of the wind turbine. Each of the rotor blades 2 has a top protrusion 7 for easy assembly into the corresponding blade of the nearest upper disk in the rotor, which is provided with a lower recess (not shown). Similarly, the central flange 8 of the disk has an annular protrusion 9 that is inserted into the central flange of the upper disk. In the final assembly, the plurality of rotor blades 2 are mounted one on top of the other and create a helically angled shape as shown in FIG. 1. In addition to providing a very easy assembly method for the rotor assembly 11, the whole structure is well reinforced as each disk 1 is tightly coupled with its corresponding top and bottom disk on the central flange as well as on a plurality of points uniformly distributed on the circumference.

The illustrated rotor blades orientation is counter clockwise. It will be understood of course that the orientation of the rotor blades 2 may be reversed to drive the turbine in a clockwise direction if desired.

A vertical shaft 12 passes through the center of each disk 1. The rotor assembly is preferably manufactured from a corrosion resistant light material, such as reinforced fiberglass composite, to rotate very easily even in slow wind.

The airflow hits with its first impulse the airfoil blades 2 and then enters in the space between two disks 10 of the rotor assembly 11. The airflow creates a laminar region on the surface of each disk 1 that extends up to 0.03 inch (0.762 mm) thick. Doubling that for the two disks and considering a transition layer, the distance between two disks is best set to be less than 0.1 inches (2.54 mm). However, the turbine rotates in the wind even with wider disk distances. Due to the Coanda effect, the airflow adheres to the disks surface adding rotational velocity to the rotor assembly 11 via the viscous pressure effect. Then, the air passes through the openings 4 of the disks 1 and creates a vortex that contributes to increase the rotation of the turbine and as a consequence its efficiency. The air currents and vortices are able to escape from said enclosure through the openings 4 of the disks 1.

As persons skilled in the art will understand, a majority of the disks may be closely spaced apart, while some of the disks may be separated by larger distances. However, the efficiency of the rotor assembly may be diminished with such configuration.

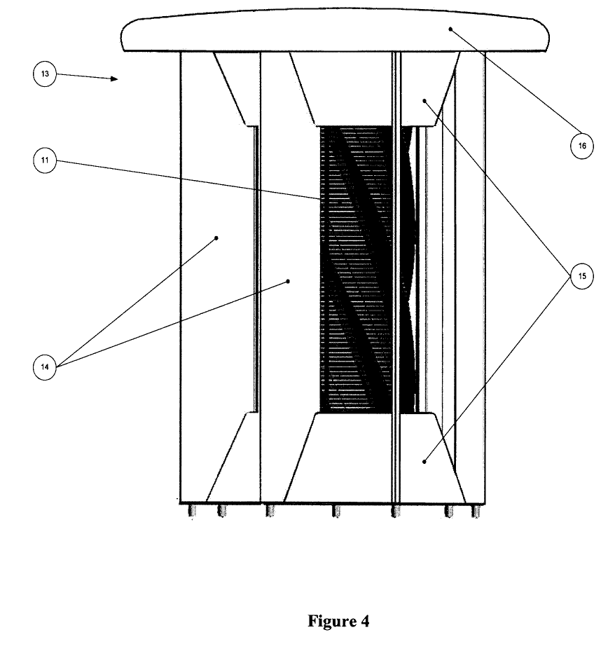

FIG. 4 is a perspective view of the turbine with an airflow augmenter stator assembly 13. The stator blades 14 of the augmenter stator assembly 13 are oriented with a relative small angle from the radial position in the rotating direction of the rotor, as such to permit the airflow to enter and exit freely into and from the rotor assembly 11. In a preferred embodiment, the augmenter stator assembly 13 has a top and a bottom truncated cones 15 that together with the stator blades 14 create a significant size difference between the inflow and the outflow openings, which in turn create a natural compression and a substantial air speed increase of the wind, that translates into a steady rotation of the turbine even in low wind. The stator assembly 13 contains a top cover 16 to prevent precipitations to get inside the top cone. Moreover, the top cover 16 redirects the airflow that normally goes over the top of the stator assembly to the back of the turbine where it is attracted toward the rotor assembly 11 due to a lower pressure region created on the back of the wind turbine.

Alternatively, the top and bottom surfaces of the stator assembly may be hemispheres or elliptical surfaces.

The rotor disks are preferably made from a light non-corrosive material, preferably a light polymer. The stator structure is preferably made from a more resistant non-corrosive material, such as a stronger type of polymer. The whole vertical axis turbine may be made from inexpensive plastic material to create a cost effective alternate power source.

Although the above description relates to a specific preferred embodiment as presently contemplated by the inventor, it will be understood that the invention in its broad aspect includes mechanical and functional equivalents of the elements described herein.

### Experimental Tests

A model of the wind turbine was simulated via specialized CFD tool and then a prototype was built as proof of concept. The prototype included a stator assembly. The prototype has one (1) meter in height and 0.70 meter in diameter and develops 600 Watts in a wind of 14 m/s.

Without limiting the possibilities of alternate embodiments, there is described below some of such functional equivalents of the boundary layer vertical axis turbine.

In alternate embodiments of the turbine:
the turbine may be placed in a horizontal axis position. Such embodiment may be used in places where the wind is known to have only one direction or it may be used in a configuration where the turbine is placed on objects in motion (such as cars, boats, etc.) to generate the required electrical power;
the surfaces of the rotor to create the boundary layer effect may be designed in different shapes instead of disks;
the disk openings may have any shape instead of arc sectors;
the rotor may be designed in a shaftless configuration with a complete circle hole in the middle instead of the arc sector openings. In this configuration the rotor structure is well reinforced as each disk is tightly coupled with its corresponding top and bottom disk on the plurality of points uniformly distributed on the circumference. The rotor has a top and bottom shaft portion attached to the corresponding top and bottom disks, thereby defining a virtual shaft;
the disks can be designed without any central openings but with a radial cut from the central flange to the circumference. The disk surface is split vertically along the radial cut with the same disk gap as described in the preferred embodiment. The rotor assembly of a plurality of such radial cut disks creates a helical surface which guides the air flow upward or downward without any need for central openings in the disks. An example of this feature is shown in FIG. 11 of WO2006089425 (NICA).

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

1. A wind turbine comprising:
a rotor assembly having a plurality of stacked disks for rotation about an axis, at least one set of the stacked disks having disks being closely spaced from each other for creating a boundary layer effect on surfaces of the disks that contributes in rotating the disks, the plurality of stacked disks having a plurality of rotor blades disposed on an outer circumference thereof, each rotor blade having at least one surface extending substantially tangentially from the outer circumference of each disk for redirecting at least a portion of the wind substantially tangentially to a peripheral surface of each disk.

2. The wind turbine according to claim 1, wherein the rotor assembly is adapted to rotate about a vertical axis.

3. The wind turbine according to claim 1, wherein the rotor assembly is adapted to rotate about a horizontal axis.

4. The wind turbine according to claim 1, wherein each of the rotor blades has an airfoil shape placed tangentially to the circumference of each disk.

5. The wind turbine according to claim 1, wherein the length of the rotor blade and the number of the rotor blades on the circumference of the disk are selected such that the gap between the tip of a blade and the tail of the next blade prevents airflow to travel in a counter-rotating direction between the disks.

6. The wind turbine according toclaim 1, wherein each of the disks has an upper and lower surfaces, at least one of the surfaces being provided with ribs for redirecting at least a portion of the wind.

7. The wind turbine according to claim 6, wherein each of the ribs is curved and projects from one corresponding rotor blade to create a spiral-like airflow within each disk.

8. The wind turbine according to claim 6, wherein the rotor blades form a helical shape.

9. The wind turbine according to claim 6, wherein between two ribs on one of the surfaces of each disk there is provided a corresponding rib on the other surface of each disk.

10. The wind turbine according to claim 6, wherein each rotor blade of each disk is adapted to be assembled into corresponding rotor blades of adjacent upper and lower disks of the rotor assembly.

11. The wind turbine according to claim 2, wherein a diameter of top and bottom disks is larger than the diameter of intermediate disks.

12. The wind turbine according to claim 2, wherein the rotor assembly is attached via a shaft to an electrical generator.

13. The wind turbine according to claim 2, wherein each of the disks defines at least one opening positioned near a center thereof for redirecting at least a portion of the wind axially through each of the disks.

14. The wind turbine according to claim 2, wherein each of the disks has a helical shape with a radial opening extending from a central flange to a circumference thereof.

15. The wind turbine according to claim 2, further comprising a stator assembly surrounding the rotor assembly, the stator assembly comprising a plurality of stator blades that impart the airflow into the rotor assembly.

16. The wind turbine according to claim 15, wherein the stator assembly comprises top and bottom surfaces containing a plurality of openings to permit air currents to escape from said rotor assembly.

17. The wind turbine according to claim 16, wherein the top and bottom surfaces are hemispheres surfaces.

18. The wind turbine according to claim 16, wherein the top and bottom surfaces are truncated cones surfaces.

19. The wind turbine according to claim 16, wherein the top and bottom surfaces are elliptical surfaces.

20. The wind turbine according to claim 1, wherein the rotor assembly includes a shaft and the stacked disks are mountably connected to the shaft.

21. The wind turbine according to claim 1, wherein the rotor assembly includes portions of the stacked disks that are coupled to one another to define a virtual shaft.
